(19) United States
(12) Patent Application Publication
(10) Pub. No.: US 2009/0003797 A1
(43) Pub. Date: Jan. 1, 2009

(54) Method, Apparatus and Computer Program Product for Providing Content Tagging

(75) Inventor: Ian Nash, Berkshire (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,038

(22) Filed: Jun. 29, 2007

(51) Int. Cl. H04N 5/91

(52) U.S. Cl. 386/95; 386/E05.003

(57) ABSTRACT

An apparatus for providing content tagging may include a storage element and a tagging element. The storage element may be configured to store a predefined text entry. The tagging element may be in communication with the storage element and may be configured to receive a content item and tag the content item with the predefined text entry.

### TECHNOLOGICAL FIELD

Embodiments of the present invention relate generally to content management technology and, more particularly, relate to a method, device, mobile terminal and computer program product for content tagging.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to store content, and given also that mobile electronic devices such as mobile phones often face limitations in display size, text input speed, and physical embodiments of user interfaces (UI), challenges are created in content management. Specifically, an imbalance between the development of stored content capabilities and the development of physical UI capabilities may be perceived.

In order to provide a solution for the imbalance described above, metadata and other content management enhancements have been developed. Metadata typically includes information that is separate from an object, but related to the object. An object may be “tagged” by adding metadata to the object. As such, metadata may be used to specify properties associated with the object that may not be obvious from the object itself. Metadata may then be used to organize the objects to improve content management capabilities.

Currently, devices such as mobile terminals are becoming more and more adept at content creation (e.g., images, videos, product descriptions, event descriptions, etc.). However, tagging of objects produced as a result of content creation is typically a challenge given the limited physical UI capabilities of mobile terminals. For example, it may be cumbersome to type in a new metadata entry for each content item created. Accordingly, although tagging objects with metadata improves content management capabilities, the efficiency of tagging may become a limiting factor.

Additionally, some methods have been developed for inserting metadata based on context. Context metadata describes the context in which a particular content item was “created”. Hereinafter, the term “created” should be understood to be defined such as to encompass also the terms captured, received, and downloaded. In other words, content is defined as “created” whenever the content first becomes resident in a device, by whatever means regardless of whether the content previously existed on other devices. Context metadata can be associated with each content item in order to provide an annotation to facilitate efficient content management features such as searching and organization features. Accordingly, the context metadata may be used to provide an automated mechanism by which content management may be enhanced and user efforts may be minimized. However, context metadata and other types of metadata may be standardized dependent upon factors such as context. Thus, tagging of content items that may have, for example, more than one context may become complicated. Furthermore, a user typically has limited control over the context and therefore limited control over tagging of content items according to the user's desires.

Thus, it may be advantageous to provide improved methods of associating metadata or tags with content items that are created, which are simpler and easier to employ in mobile environments.

### BRIEF SUMMARY

A method, apparatus and computer program product are therefore provided to enable efficient content tagging. In particular, a method, apparatus and computer program product are provided that allow a user, for example, of a mobile terminal such as, for example, a mobile phone having camera functionality or a digital camera, to automatically associate a particular predefined text tag with a particular content item such as an image. In an exemplary embodiment, tags may be predefined and provided for user utilization in automatic tagging. Thus, the user can select a tag to be associated with images created prior to creating the images and, during creation of the images, each image created may be associated with the selected tag. Accordingly, more efficient tagging may be performed for created content. Specifically, despite having a limited user interface, or even despite having an inability to enter text to associate with a created content item, the user may still assign, automatically or manually, a text based tag to be associated with the created content item. Thus, text entries may be associated with content, without any requirement for the user to enter the text either prior to, or after, the creation of the associated content. Accordingly, the efficiency and universality of metadata tag usage may be increased and content management for mobile terminals may be improved.

In one exemplary embodiment, a method of providing content tagging is provided. The method includes storing a predefined text entry, creating a content item, and tagging the content item with the predefined text entry.

In another exemplary embodiment, a computer program product for providing content tagging is provided. The computer program product includes at least one computer-readable storage medium having computer-readable program code portions stored therein. The computer-readable program code portions include first, second and third executable portions. The first executable portion is for storing a predefined text entry. The second executable portion is for creating a content item. The third executable portion is for tagging the content item with the predefined text entry.

In another exemplary embodiment, an apparatus for providing content tagging is provided. The apparatus may include a storage element and a tagging element. The storage element may be configured to store a predefined text entry. The tagging element may be in communication with the storage element and may be configured to receive a content item and tag the content item with the predefined text entry.

In another exemplary embodiment, an apparatus for providing content tagging is provided. The apparatus includes means for storing a predefined text entry, means for creating a content item, and means for tagging the content item with the predefined text entry.

Embodiments of the invention may provide a method, apparatus and computer program product for advantageous employment in a mobile electronic device environment, such as on a mobile terminal capable of creating content items and objects related to various types of media. As a result, for example, mobile terminal users may enjoy an improved content management capability.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of a system for providing content tagging according to an exemplary embodiment of the present invention;

FIG. 4A illustrates an example of a display from which a user may make selections to perform content tagging according to an exemplary embodiment of the present invention;

FIG. 4B illustrates another example of a display from which a user may make selections to perform content tagging according to an exemplary embodiment of the present invention;

FIG. 5 an example of displays and links therebetween according to an exemplary embodiment of the present invention; and

FIG. 6 is a block diagram according to an exemplary method for providing content tagging according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

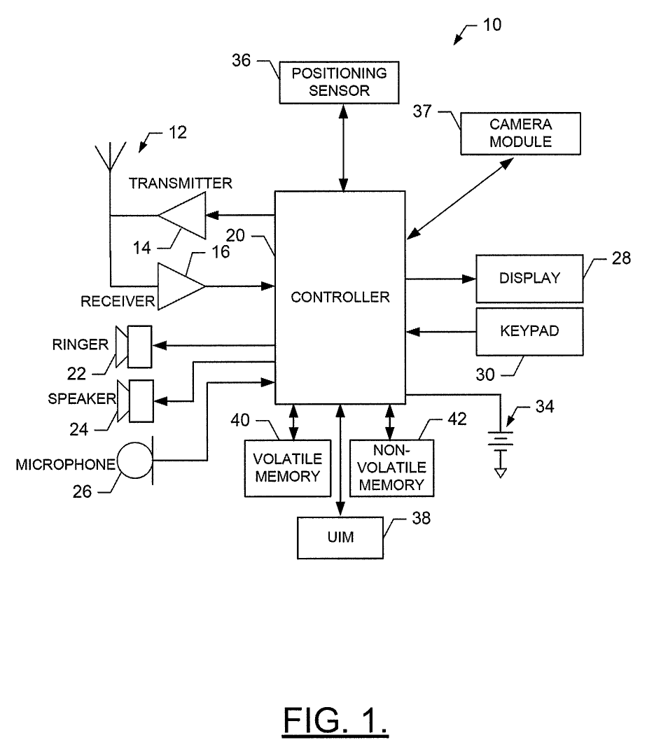

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention. Furthermore, devices that are not mobile may also readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output. In addition, the mobile terminal 10 may include a positioning sensor 36. The positioning sensor 36 may include, for example, a global positioning system (GPS) sensor, an assisted global positioning system (Assisted-GPS) sensor, etc. However, in one exemplary embodiment, the positioning sensor 36 includes a pedometer or inertial sensor. In this regard, the positioning sensor 36 is capable of determining a location of the mobile terminal 10, such as, for example, longitudinal and latitudinal directions of the mobile terminal 10, or a position relative to a reference point such as a destination or start point.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

In an exemplary embodiment, the mobile terminal 10 includes a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 includes all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG standard format.

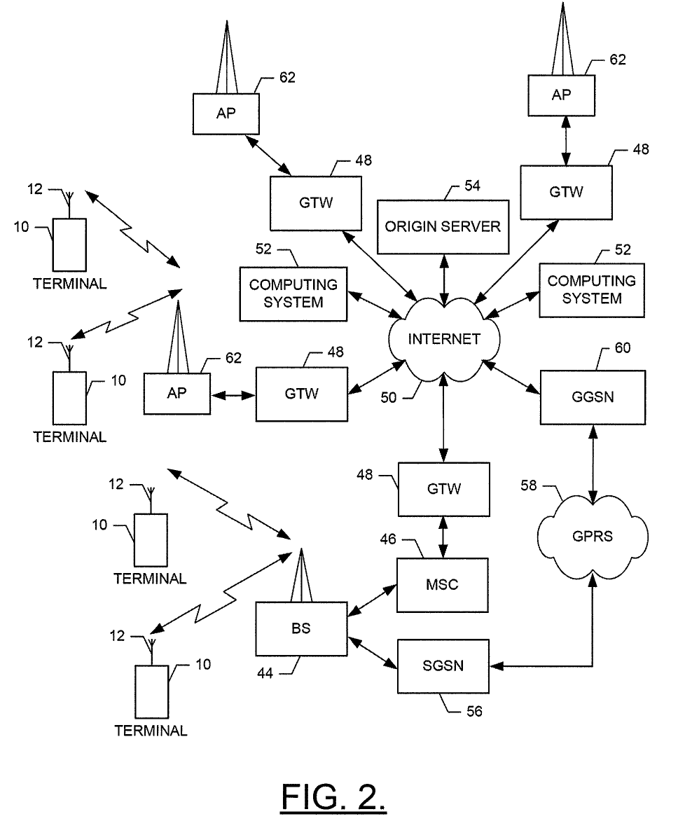

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera or other device, absent any communication with the system of FIG. 2. For example, a camera may employ embodiments of the present invention. Such camera may be capable of communication with a PC or laptop computer or with the Internet for downloading or uploading of content created at the camera.

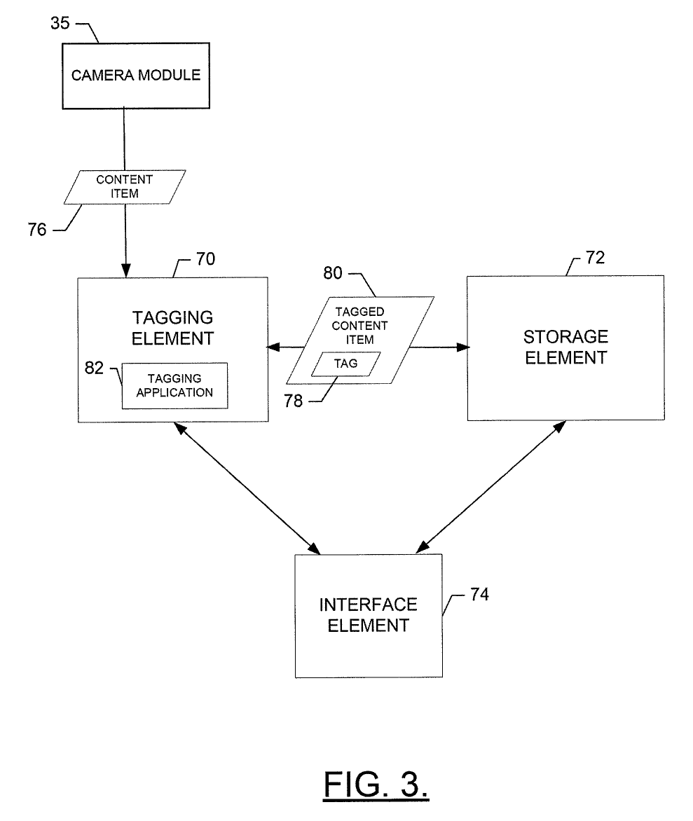

An exemplary embodiment of the invention will now be described with reference to FIG. 3, in which certain elements of a system for providing content tagging are displayed. The system of FIG. 3 may be employed, for example, on the mobile terminal 10 of FIG. 1. However, it should be noted that the system of FIG. 3, may also be employed on a variety of other devices, both mobile and fixed, and therefore, the present invention should not be limited to application on devices such as the mobile terminal 10 of FIG. 1. For example, the system of FIG. 3 may be employed on a personal computer, a camera, a video recorder, etc. Alternatively, embodiments may be employed on a combination of the devices including, for example, those listed above. It should also be noted, however, that while FIG. 3 illustrates one example of a configuration of a system for providing content tagging for use, for example, in metadata-based content management, numerous other configurations may also be used to implement embodiments of the present invention.

Referring now to FIG. 3, a system for providing content tagging is provided. The system includes a tagging element 70, an interface element 72, and a storage element 74. It should be noted that any or all of the tagging element 70, the interface element 72, and the storage element 74 may be collocated in a single device. For example, the mobile terminal 10 of FIG. 1, may include all of the tagging element 70, the interface element 72, and the storage element 74. Alternatively, any or all of the tagging element 70, the interface element 72, and the storage element 74 may be disposed in different devices. For example, one or more of the tagging element 70, the interface element 72, and the storage element 74 may be disposed at a server or remote display, while others are disposed at a mobile terminal in communication with the server or remote display.

In an exemplary embodiment, the tagging element 70 may be embodied in software instructions stored in a memory of the mobile terminal 10 and executed by a processing element such as the controller 20. Alternatively, the tagging element 70 may be embodied in a processing element. The interface element 72 may include, for example, the keypad 30 and the display 28 and associated hardware and software. It should be noted that the interface element 72 may alternatively be embodied entirely in software, such as is the case when a touch screen is employed for interface using functional elements such as software keys accessible via the touch screen using a finger, stylus, etc. As another alternative, the interface element 72 may be a simple key interface including a limited number of function keys, each of which may have no predefined association with any particular text characters. As such, the interface element 72 may be as simple as a display and a single key for selecting a highlighted option on the display for use in conjunction with a mechanism for highlighting various menu options on the display prior to selection thereof.

The storage element 74 may be any means, such as any of the memory devices described above in connection with the mobile terminal 10 of FIG. 1, or any other suitable memory device which is accessible by a processing element and in communication with the tagging element 70 and the interface element 72. It should also be noted that although embodiments of the present invention will be described below primarily in the context of content items that are still images such as pictures or photographs, any other content item that may be created at the mobile terminal 10 or any other device employing embodiments of the present invention is also envisioned. For example, one alternative may be video which is currently recorded by a device. The user can easily add a tag to the video according to an embodiment of the invention. Additionally, processing elements such as those described herein may be embodied in many ways. For example, the processing element may be embodied as a processor, a coprocessor, a controller or various other processing means or devices including integrated circuits such as, for example, an ASIC (application specific integrated circuit).

The tagging element 70 may be any device or means embodied in either hardware, software, or a combination of hardware and software that is capable of performing tag management functions. For example, a tag management function may include associating a predefined text based tag with created content. Additionally or alternatively, the tagging element 70 may be configured to enable other tag management functions such as tag creation, tag editing, manually assigning tags to content, defining rules for automatic tag assignment to content, viewing information related to tags or other metadata, or the like. In this regard, for example, the content may be a content item 76 such as an image created by the camera module 37 (although as indicated above, the content item 76 could be downloaded or received from another device as well). The tagging element 70 may be configured to add or associate a tag 78 to the content item 76 in order to create a tagged content item 80. The tagged content item 80 may be stored in the storage element 74, as shown in FIG. 3, or another device, or may be communicated to the interface element 72 such as for display of at least a portion of the tagged content item 80.

In accordance with embodiments of the present invention, the tag 78 may be considered as a form of metadata. However, unlike typical metadata such as context metadata (e.g., time, date, proximity information, location, etc.) over which the user has no authoring capability to define the metadata, the tag 78 according to embodiments of the present invention may include, for example, a text entry that is determinable and/or selectable by the user. In this regard, for example, the text entry may be a predefined text entry for associating a particular word (e.g., keyword), phrase or character sequence with one or more content items that are associated with (or tagged) with the tag 78. In an exemplary embodiment, the storage element 74 may include a tag library for storing a list of predefined text entries which may be used as tags. As an example, the predefined text entries may be provided by a manufacturer of a device employing embodiments of the invention, or the predefined text entries may be acquired from another device (e.g., downloaded from the Internet, received from a friend, etc.) or the predefined text entries may be created and stored by a user of the device or modified from existing predefined text entries.

According to one exemplary embodiment, the user may tag existing or newly created content items with the tag 78. For example, after creating an image with the camera module 37, the user may select an option to add a tag, or automatically be prompted to add a tag to the image. As an alternative embodiment, upon downloading an image from another device or the Internet, the user may select an option to add a tag, or automatically be prompted to add a tag to the image. In this regard, the user may, for example, scroll through previously existing (e.g., stored) text entries in order to select a predefined text entry for association with the image. As an alternative, the user could (e.g., if a keyboard or other text entry interface is available) enter a text entry for use as a tag thereafter and assign the tag to the image and have the tag available for future use with other content items.

According to another exemplary embodiment, the user may utilize the interface element 72 to input or select rules for automatic tag assignment. For example, the interface element 72 may provide one or more setting options for the use of tagging. Rules and/or setting options may be simple in nature (e.g., either on/off or automatic/manual). Alternatively, conditional rules may be provided, for example, using Boolean expressions. If the use of tagging is selected for automatic assignment, the tagging element 70 may be configured to receive a user selection (or entry) of the predefined text entry (e.g., keyword) to be utilized for tagging future content items. In this regard, the selected keyword may be employed for tagging all content items created until a different keyword is selected (or entered), until automatic assignment is turned off, or until conditional rules dictate the use of a different keyword.

In exemplary embodiments in which, rather than entering text for creation of a tag, the user selects (or the tagging element 70 automatically selects) the tag 78 from among predefined text entries, either automatic tagging as described above may be performed, or a camera or other device having a limited user interface not suitable for text entry may still be utilized for text based tagging since predefined text entries may be used for the tagging via a simple (e.g., a single key) interface.

In an exemplary embodiment, the process of tagging a content item, as described above, may be performed by executing a tagging application 82. In this regard, the tagging application 82 may include, for example, a gallery application configured to enable a user to view tagged content items, locate content items based on a tag, edit tags, etc. The tagging application 82 may also include or otherwise work in conjunction with means, such as a camera application configured to communicate with the camera module 37, to create and tag content items captured or provided by the camera application.

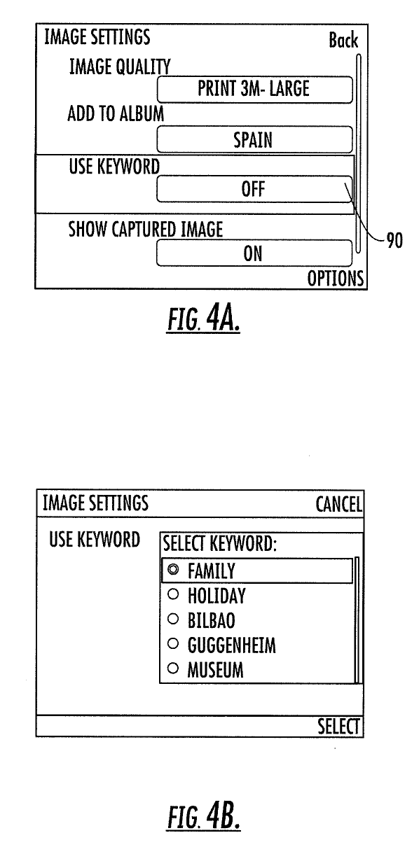

FIG. 4 illustrates an example of displays from which a user may make selections to perform content tagging in accordance with embodiments of the present invention. In this regard, FIG. 4A illustrates an image setting display in which a “Use keyword” feature is displayed with a corresponding tagging function on/off field 90. The tagging function on/off field 90 may be selected to “Off” to turn automatic tagging off, or selected to “On” to turn automatic tagging on. If automatic tagging is turned on, a keyword selection option may be displayed from which a keyword (e.g., the tag 78) to be used for tagging created content may be selected as shown in FIG. 4B. Referring to FIG. 4B, a tag library or list of keywords may be displayed and one of the keywords may be selected. In response to the selection of a particular one of the keywords such as “Family”, each subsequent creation of a content item (e.g., capturing an image using the camera module 37) may trigger the automatic assignment of the tag “Family” to the created content item. Accordingly, a plurality of content items (e.g., images) may be identified or associated with each other based on sharing the same tag. As an alternative to automatic tagging, upon creating each content item, the user may be prompted to or otherwise independently select (e.g., by scrolling and selecting a tag from the tag library) the tag 78 to be associated with each created content item.

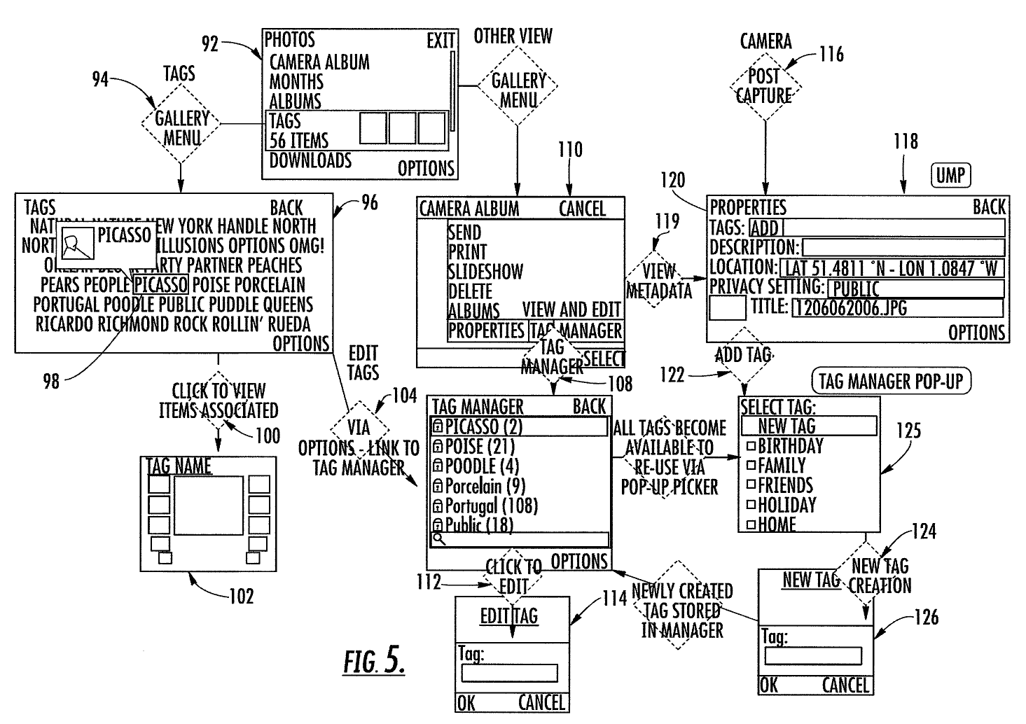

FIG. 5 illustrates an example of displays and links between such displays according to an exemplary embodiment of the present invention. In this regard, as shown on display 92, the gallery application may provide a menu. Selection of various menu items such as a “Camera album” may link to an album populated with content items. Selection of the “Tags” option at operation 94 may direct the user to a tag library 96. The tag library 96 may show all or a portion of the tags that are currently available. A highlight window 98 may be moved over an individual tag of the tag library 96 to, for example, highlight a corresponding individual tag. Accordingly, when highlighted, a semi-transparent window may be displayed illustrating a thumbnail of at least one content item having the highlighted tag and/or a number indicating how many content items are associated with the highlighted tag. In response to selection of the highlighted tag at operation 100, a tagged item preview 102 may be displayed. The tagged item preview 102 may display the tag name of the selected tag and all or a portion of the images (e.g., as thumbnails) associated with the selected tag. In an exemplary embodiment, one of the images associated with the selected tag may be displayed while a plurality of other images associated with the selected tag may be displayed as thumbnail images.

As shown in FIG. 5, the tag library 96 may include an option menu item, the selection of which at operation 104 may provide a link to a tag manager 106. The tag manager 106 may illustrate, in a list format (e.g., in alphabetical or any other desired order), all or a portion of the existing tags from the tag library 96. In an exemplary embodiment, as shown in FIG. 5, the tag manager 106 may also display an indication of the number of content items associated with each tag. In an exemplary embodiment, the tag manager 106 may also be reached via selection of a “Tag manager” option 108 under the “Camera album” display 110. Selection of a particular tag from the tag manager 106 at operation 112 may enable a user to edit the particular tag as indicated at display 114. A new keyword or sequence of text characters may be entered to define the particular tag.

As indicated by FIG. 5, after an image is captured by the camera module 37 at operation 116, the image may automatically or manually be assigned with a tag. As indicated by a unified metadata pane (UMP) 118, all metadata associated with the image may be viewed. The UMP 118 may be accessed from the properties of the image itself or from a menu option in a particular album as indicated at 119. In addition to standard metadata such as location, description, title, etc., the UMP 118 may include a “Tag” field 120. The “Tag” field 120 may indicate the tag associated with the image (e.g., if automatically or previously assigned) or may enable the user to add a text entry to associate with the image as a tag. In this regard, for example, if the user selects the “Add” option at operation 122, the user may be enabled to select a tag from among those listed in the tag library, or select a new tag at operation 124 via a pop-up picker 125. If selection of a new tag is desired, the user may enter text corresponding to the new tag as indicated at display 126. Entry of the new tag adds the new tag to the list of available tags in the tag manager 106 (and adds the tag to the tag library 96).

In an exemplary embodiment, in addition to providing text for use as the tag 78, the predefined text entry may also be used to provide a prefix or other portion of the title of the image. Accordingly, rather than utilizing a default prefix for the title of an image or requiring the user to enter text for the title, the predefined text entry associated with the tag 78 may be utilized.

As indicated above, some devices capable of employing embodiments of the present invention may not have text entry capability on a per character basis. Accordingly, embodiments of the present invention provide a mechanism by which devices with limited or no ability to enter text characters to define a text entry may still be enabled to utilize manual or automatic tagging with a text based tag. Thus, content creation devices may be provided with a robust capability for tagging content with text based metadata that can be controlled and tailored to the user's desires. However, even for devices with limited or no text entry capability on a per character basis, it may be possible for such device to be placed in communication with another device (e.g., a computer) to enable the upload of new tags to the device with limited or no text entry capability on a per character basis. Thus, even these devices may be able to tailor text based metadata to the user's desires.

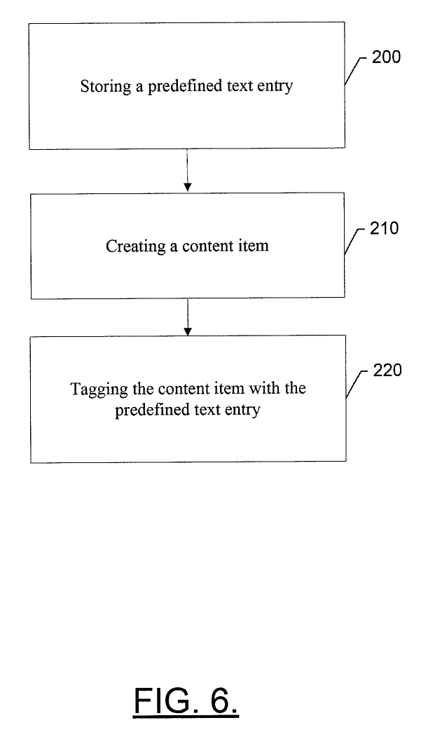

FIG. 6 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing content tagging with a user specified text entry includes storing a predefined text entry at operation 200. The predefined text entry may be stored for utilization in providing a user specified metadata tag. The predefined text entry may be one of a plurality of predefined text entries stored in a tag library. At operation 210, a content item may be created. It should be noted that creation of the content item may include, for example, capturing, receiving, and downloading a content item. The content item may then be tagged with the predefined text entry at operation 220. The tagging of the content item may be performed automatically in response to creation of the content item, or manually by a user. The tag comprising the predefined text entry may then be reused for a plurality of content items to thereby associate each of the plurality of content items via an identical text based portion of metadata (i.e., the tag).

In an exemplary embodiment, storing the predefined text entry may further include storing a plurality of predefined text entries in a tag library, and tagging the content item may include selecting one of the plurality of predefined text entries to associate with the content item. Selecting one of the plurality of predefined text entries may include, for example, receiving a user input selecting the one of the plurality of predefined text entries or automatically selecting the one of the plurality of predefined text entries based on predefined rules.

In an exemplary embodiment, contents of the tag library may be displayed along with an indication of a number of content items associated with each respective predefined text entry of the tag library. Accordingly, a user may be enabled to access one or more content items on the basis of the predefined text entry associated with each of the one or more content items. In another exemplary embodiment, the predefined text entry may be utilized for defining a prefix portion of a title of the content item.

Embodiments of the present invention may provide for improved content management since the user may specify metadata in the form of a predefined text entry that is used to tag one or more content items. Thus, since the predefined text entry for each tag comprises an identical tag for all associated content items, the user may be enabled to sort, search, organize, etc., a vast library of content items based on metadata (e.g., the tag) that can be automatically assigned to each content item when the content item is created. Furthermore, as indicated above, the predefined text entry can also be used for other purposes such as providing a prefix portion of file name or titles for content items. Thus, the tag of embodiments of the present invention, which is, in its entirety, identical for each associated content item, may be used to define content having a particular theme or genre into an album or a particular gallery by virtue only of the tag. In other words, even if a default filename or title were associated with a plurality of content items, such content items may still be distributed over various folders or albums. However, content items having the same tag are, by virtue of sharing the same tag, essentially within the same virtual album via their association through the tag via, for example, the tag library.

Embodiments of the present invention may also provide a user with an ability to view and/or consume content such as images or video while remaining in the native orientation for the content type and activity purpose (e.g., landscape). For example, absent embodiments of the present invention, when a user tags a particular item with text entry at a mobile terminal, the user may be required to operate the mobile terminal to provide a portrait orientation in order to complete text entry. However, using embodiments of the present invention, the user can tag an item while still in landscape orientation via selection of the predefined text entry in the tag library in order to avoid disruption of the orientation of the mobile terminal.

It should be noted that although the preceding exemplary embodiments were described mainly in the context of image related content items, embodiments of the present invention may also be practiced in the context of any other content item. For example, content items may include, but are not limited to images, video files, television broadcast data, text, web pages, web links, audio files, radio broadcast data, broadcast programming guide data, location tracklog, etc. Although in one exemplary embodiment, the same device may be used to enter text characters to define the predefined text entry and to store the predefined text entry in a tag library, it should also be noted that embodiments of the present invention need not be confined to application on a single device. In other words, some operations of a method according to embodiments of the present invention may be performed on one device, while other operations are performed on a different device. Similarly, one or more of the operations described above may be performed by the combined efforts of means or devices in communication with each other. For example, the predefined text entry may be provided by character entry at a device different from the device storing the predefined text entry. Such may be the case, for example, when a digital camera having no direct text entry capability (e.g., no keyboard with corresponding text characters) is placed in communication with a computer and the computer is used to enter a predefined text entry, which may then be stored at the digital camera in a tag library. As another example, one device could download a predefined text entry into its tag library from the tag library of another device.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
storing a predefined text entry;
creating a content item; and
tagging the content item with the predefined text entry.

2. A method according to claim 1, wherein storing the predefined text entry further comprises storing a plurality of predefined text entries in a tag library; and
wherein tagging the content item comprises selecting one of the plurality of predefined text entries to associate with the content item.

3. A method according to claim 2, wherein selecting one of the plurality of predefined text entries further comprises receiving a user input selecting the one of the plurality of predefined text entries.

4. A method according to claim 2, wherein selecting one of the plurality of predefined text entries further comprises automatically selecting the one of the plurality of predefined text entries based on a predefined rule.

5. A method according to claim 1, wherein tagging the content item comprises automatically tagging the content item in response to creation of the content item.

6. A method according to claim 1, further comprising displaying contents of a tag library along with an indication of a number of content items associated with each respective predefined text entry of the tag library.

7. A method according to claim 6, further comprising enabling a user to access one or more content items on the basis of the predefined text entry associated with each of the one or more content items.

8. A method according to claim 1, wherein creating the content item comprises creating one of:
an image;
a video file;
an audio file;
a television broadcast;
a radio broadcast;
text
location tracklog; or
a web page.

9. A method according to claim 1, further comprising utilizing the predefined text entry for defining a prefix portion of a title of the content item.

10. A method according to claim 1, wherein storing the predefined text entry comprises entering text characters comprising the predefined text entry at a device different from the device storing the predefined text entry.

11. A method according to claim 1, wherein storing the predefined text entry comprises entering text characters comprising the predefined text entry at a same device as a device storing the predefined text entry.

12. A computer program product comprising at least one computer-readable storage medium having computer-readable program code portions stored therein, the computer-readable program code portions comprising:
a first executable portion for storing a predefined text entry;
a second executable portion for creating a content item; and
a third executable portion for tagging the content item with the predefined text entry.

13. A computer program product according to claim 12, wherein the first executable portion includes instructions for storing a plurality of predefined text entries in a tag library; and
wherein the third executable portion includes instructions for selecting one of the plurality of predefined text entries to associate with the content item.

14. A computer program product according to claim 13, wherein the third executable portion includes instructions for receiving a user input selecting the one of the plurality of predefined text entries.

15. A computer program product according to claim 13, wherein the third executable portion includes instructions for automatically selecting the one of the plurality of predefined text entries based on a predefined rule.

16. A computer program product according to claim 12, wherein tagging the third executable portion includes instructions for automatically tagging the content item in response to creation of the content item.

17. A computer program product according to claim 12, further comprising a fourth executable portion for displaying contents of a tag library along with an indication of a number of content items associated with each respective predefined text entry of the tag library.

18. A computer program product according to claim 17, further comprising a fifth executable portion for enabling a user to access one or more content items on the basis of the predefined text entry associated with each of the one or more content items.

19. A computer program product according to claim 12, wherein the second executable portion includes instructions for creating one of:
an image;
a video file;
an audio file;
a television broadcast;
a radio broadcast;
text;
location tracklog; or
a web page.

20. A computer program product according to claim 12, further comprising utilizing the predefined text entry for defining a prefix portion of a title of the content item.

21. A computer program product according to claim 12, wherein the first executable portion includes instructions for entering text characters comprising the predefined text entry at a device different from the device storing the predefined text entry.

22. A computer program product according to claim 12, wherein the first executable portion includes instructions for entering text characters comprising the predefined text entry at a same device as a device storing the predefined text entry

23. An apparatus comprising:
a storage element configured to store a predefined text entry; and
a tagging element in communication with the storage element and configured to receive a content item and tag the content item with the predefined text entry.

24. An apparatus according to claim 23, wherein the storage element is further configured to store a plurality of predefined text entries in a tag library; and
wherein the tagging element is configured to select one of the plurality of predefined text entries to associate with the content item.

25. An apparatus according to claim 24, further comprising an interface element in communication with the tagging element, wherein the interface element is configured to receive a user input selecting the one of the plurality of predefined text entries.

26. An apparatus according to claim 24, wherein the tagging element is configured to automatically select the one of the plurality of predefined text entries based on a predefined rule.

27. An apparatus according to claim 23, wherein the tagging element is configured to automatically tag the content item in response to creation of the content item.

28. An apparatus according to claim 23, further comprising an interface element in communication with the tagging element and configured to display contents of a tag library along with an indication of a number of content items associated with each respective predefined text entry of the tag library.

29. An apparatus according to claim 28, wherein the interface element is further configured to enable a user to access one or more content items on the basis of the predefined text entry associated with each of the one or more content items.

30. An apparatus according to claim 23, wherein the content item comprises one of:
an image;
a video file;
an audio file;
a television broadcast;
a radio broadcast;
text;
location tracklog; or
a web page.

31. An apparatus according to claim 23, wherein the tagging element is configured to utilize the predefined text entry for defining a prefix portion of a title of the content item.

32. An apparatus according to claim 23, further comprising an interface element in communication with the tagging element and configured to enable entry of text characters comprising the predefined text entry at a device different from the device storing the predefined text entry.

33. An apparatus according to claim 23, further comprising an interface element in communication with the tagging element and configured to enable entry of text characters comprising the predefined text entry at a same device as a device storing the predefined text entry.

34. An apparatus comprising:
means for storing a predefined text entry;
means for creating a content item; and
means for tagging the content item with the predefined text entry.

35. An apparatus according to claim 34, wherein means for storing the predefined text entry further comprises means for storing a plurality of predefined text entries in a tag library; and
wherein means for tagging the content item comprises means for selecting one of the plurality of predefined text entries to associate with the content item.
